(19) United States
(12) Patent Application Publication
(10) Pub. No.: US 2012/0132602 A1
(43) Pub. Date: May 31, 2012

(54) SHELF UNIT

(76) Inventor: David A. Millspaugh, Lawton, OK (US)

(21) Appl. No.: 13/150,888

(22) Filed: Jun. 1, 2011

Related U.S. Application Data
(60) Provisional application No. 61/350,227, filed on Jun. 1, 2010.

(51) Int. Cl. A47B 96/02; B32B 37/00

(52) U.S. Cl. 211/90.04; 156/60

(57) ABSTRACT

A shelf unit including a mounting plate, a first shelf member extending perpendicularly from the mounting plate, a second shelf member extending perpendicularly from the mounting plate such that the second shelf member is vertically and horizontally offset from the first shelf; and a third shelf member extending perpendicularly from the mounting plate such that the third shelf member is vertically and horizontally offset from the first shelf member, and an adhesive applied to at least a portion of the rear surface of the mounting plate.

### CROSS REFERENCE TO RELATED APPLICATIONS

This application claims benefit of U.S. Provisional Application No. 61/350,227, filed Jun. 1, 2010, which is hereby incorporated herein by reference in its entirety.

### BACKGROUND OF THE INVENTION

1. Field of the Invention

The inventive concepts disclosed herein relate generally to a shelf unit, and more particularly, but not by way of limitation, to a shelf unit adapted to be secured to a vertical surface of a shower or bathtub.

### BRIEF DESCRIPTION OF THE SEVERAL VIEWS OF THE DRAWINGS

FIG. 1 is one embodiment of a perspective view of a shelf unit constructed in accordance with the present invention.

FIG. 2 is a front elevational view of the shelf unit.

FIG. 3 is a rear elevational view of the shelf unit.

FIG. 4 is a bottom plan view of the shelf unit.

FIG. 5 is a top plan view of the shelf unit.

FIG. 6 is a left side elevational view of the shelf unit.

FIG. 7 is a right side elevational view of the shelf unit.

### DETAILED DESCRIPTION OF EXEMPLARY EMBODIMENTS

Referring now to the drawings, one embodiment of a shelf unit 10 constructed in accordance with the present invention is shown. Generally, the shelf unit 10 is adapted to be connected to a vertical structure, such as a wall, so as to support a plurality of personal effects and the like. In one embodiment, the shelf unit 10 is more particularly adapted to be secured to a wall within a shower or bathtub to support personal grooming and toiletry items and the like. As will be described in more detail below, the shelf unit 10 can be connected to a shower or bathtub wall such that it can securely support such items in the high moisture environment that would be normally associated with a shower or bathtub.

The shelf unit 10 includes a mounting plate 12, a first shelf member 14, a second shelf member 16, and a third shelf member 18. The shelf unit 10 can be constructed as a unitary piece from a strong, rigid material, such as polycarbonate, stainless steel, glass, and the like. However, in other embodiments, the shelf unit 10 can be constructed of a plurality of components adapted to be assembled or otherwise attached together to form the shelf unit 10. The shelf unit 10 is further understood to be constructed to include a thickness necessary to support a desired load. As would be understood in the art, the thickness of the components of the shelf unit 10 described herein can include a material thickness sufficient to support the desired load for a given application. It is also to be understood that the thickness of each component of the shelf unit 10 can be the same or can be different based on the intended use of the shelf unit 10.

The mounting plate 12 is a planar member having a front surface 17, a rear surface 19, a first end 20, a second end 22, a top end 24, and a bottom end 26. The mounting plate 12 may be formed to have a variety of configurations. In one embodiment, the mounting plate 12 has a central section 29 and a pair of lateral sections 31 and 32. The central section 29 is generally rectangular in shape, but may be configured in a number of different shapes. The lateral sections 30 and 32 may also be formed in a variety of configurations. As shown, the lateral sections 30 and 32 are shorter than the central section 29, but configured to enhance the strength of the mounting plate 12, as well as enhance the aesthetics of the mounting plate 12. To this end, the mounting plate 12 is shown to have a curved transition, but other configurations may be used, such as stepped, angled, and the like. It will be appreciated that the lateral sections 30 and 32 may also be formed to have a height that is identical to the central section 29 whereby the delineation between the central section 29 and the lateral sections 30 and 32 is not discernable.

The mounting plate 12 is intended to be mounted to a vertical surface, such as a bathroom or shower wall. In one embodiment, an adhesive is applied to the rear surface 19 of the mounting plate 12 to secure the mounting plate 12 to the vertical wall. In the embodiment shown herein, an adhesive 25 (FIG. 3) is applied to the rear surface 19 of the mounting plate 12 adjacent at least a portion of the top 24 and the bottom 26. One example of an adhesive product suitable as an adhesive 25 for use with the present invention is the 4910 family of VHB™ Acrylic Foam Tape manufactured by 3M™ headquartered in St. Paul, Minn. To ensure that the adhesive 25 remains effective, a sealant, such as a silicone sealant, may be applied along the perimeter of the mounting plate 12.

It should be appreciated that other securing mechanisms may also be utilized to secure the shelf unit 10 to a vertical surface, such as mechanical securing mechanisms and the like. That is, the mounting plate 12 can include at least one opening formed therein or, created post-construction via drilling and the like, cut through a thickness of the mounting plate 12, so as to permit a screw, nail or the like, to be used to secure the mounting plate 12, and thus the shelf unit 10 to the surface structure.

The first shelf member 14 extends perpendicularly from the central section 29 of the mounting plate 12 from a location at or near the top end 24 of the mounting plate 12. In one embodiment, the first shelf member 14 extends along the entire length of the central section 29 of the mounting plate 12. The first shelf member 14 has a planar surface oriented substantially perpendicular to the mounting plate 12.

The first shelf member 14 can further include one or more openings 40 positioned at each end thereof. The openings 40 can be included in the first shelf member 14 during manufacture or construction, e.g., as a part of the molding process. However, the openings 40 can be added in the first shelf member 14 post-construction, e.g., through drilling and the like. Although the first shelf member 14 is shown having two openings 40 positioned at opposite ends thereof, it is to be understood that any number of openings 40 can be provided and that the openings 40 can be positioned at any location of the first shelf member 14. Also, although the openings 40 are shown as being substantially square, it is to be understood that a variety of shapes can be utilized without departing from the scope of the invention. The openings 40 can be provided for a variety of reasons, such as allowing water to run off. The plurality of openings 40 can also be included so as to provide a storage mechanism whereby a user inserts items into the openings 40 to secure the items. For example, the user can insert a toothbrush or razor into the openings 40 to support the items for ready access. The openings 40 can further be included so as to provide a place for the user to insert a hanger or hook type device to support the device from the first shelf member 14.

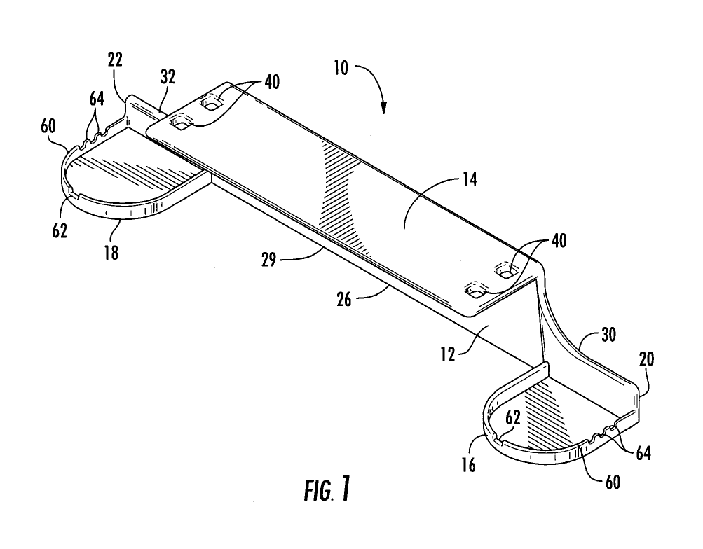

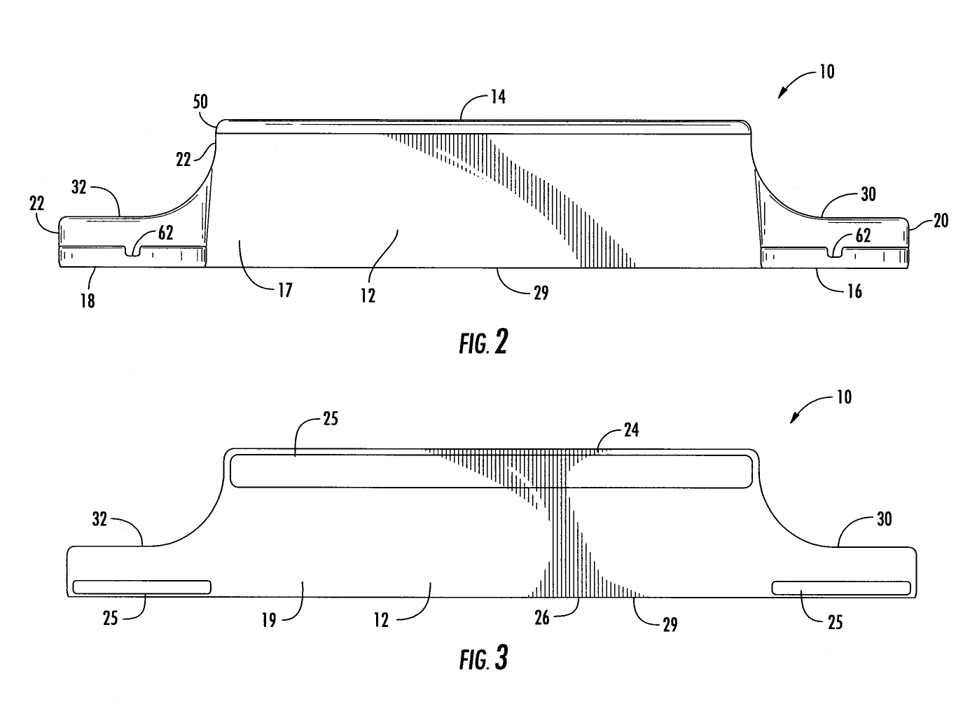

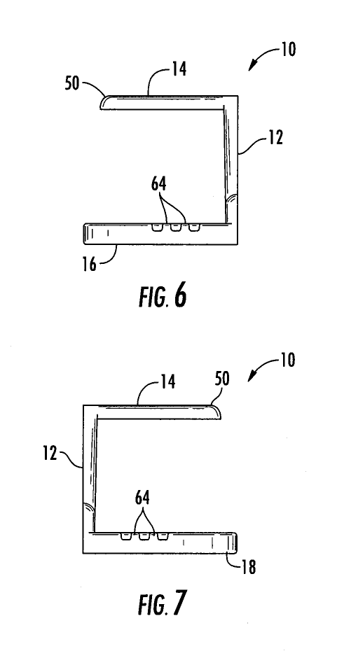

The first shelf member 14 can further be provided with a decorative edge along its periphery. For example, as best shown in FIGS. 1-2 and 6-7, the first shelf member 14 can include an edge 50. Although the edge 50 is shown as having a radius edge, other configurations are considered within the scope of the presently described concepts, such as ogee, chamfer, bullnose and the like.

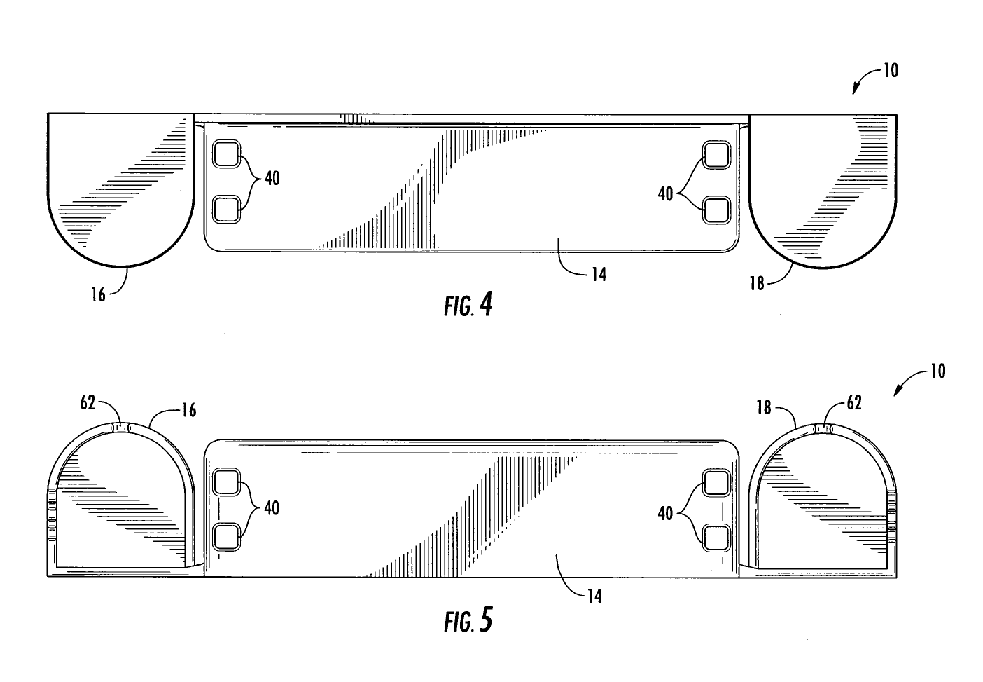

In one embodiment, the second and third shelf members 16 and 18 extend perpendicularly from the lateral sections 30 and 32, respectively, and are formed on opposite ends of the mounting plate 12 in a co-planar relationship to one another. As best shown in FIGS. 4-5, the second and third shelf members 16 and 18 are positioned so as to extend from or near the bottom end 26 of the mounting plate 12 and beyond the respective ends of the first shelf member 14. Consequently, with the first shelf member 14 positioned on or near the top end 24 of the mounting plate 12 and the second and third shelf members 16 and 18 positioned on or near the bottom end 26 of the mounting plate 12, the second shelf member 16 and the third shelf member 18 are vertically and horizontally offset from the first shelf member 14.

The second and third shelf members 16 and 18 may further include a lip 60 extending along at least a portion of their periphery. The lip 60 can be provided so as to provide lateral support to items disposed on the shelf members 16 and 18. The lip 60 can further include one or more openings 62 to permit water to run off the shelf members 16 and 18. The lip 60 can further include one or more hooks 64.

It is to be understood that other variations of the shelf unit 10 can be incorporated without departing from the scope of the presently described concepts. For example, the shelf unit 10 can include one or more angled mounting plates between the first shelf member 14 and the mounting plate 12 to increase the vertical strength of the first shelf member 14. As another example, the first, second, or third shelf members 14, 16, and 18, or combinations thereof, can further be constructed to include a relief or cutout extending within at least a portion of their thickness to reduce the weight of the shelf members without reducing the supporting strength thereof.

In operation, the shelf unit 10 is attached to a vertical structure using any one of the aforementioned mechanisms, or combinations thereof. Once securely attached to the vertical structure, items may be stored on the first, second, or third shelf members 14, 16, and 18.

From the above description, it is clear that the present invention is well adapted to carry out the objects and to attain the advantages mentioned herein, as well as those inherent in the invention. While exemplary embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A shelf unit, comprising:
a mounting plate having a front surface, a rear surface, a top end, a bottom end, a first side, and a second side, wherein the mounting plate is adapted to be secured to a vertical structure;
a first shelf member extending perpendicularly from the mounting plate, the first shelf member having a first end and a second end; and
a second shelf member extending perpendicularly from the mounting plate such that the second shelf member is vertically and horizontally offset from the first shelf member.

2. The shelf unit of claim 1 further comprising a third shelf member extending perpendicularly from the mounting plate such that the third shelf member is vertically and horizontally offset from the first shelf member.

3. The shelf unit of claim 2 wherein the second shelf member extends beyond the first end of the first shelf member, and wherein the third shelf member extends beyond the second end of the first shelf member.

4. The shelf unit of claim 3 wherein the second shelf member and the third shelf member are in a co-planar relationship with respect to one another.

5. The shelf unit of claim 3 wherein the mounting plate, the first shelf member, the second shelf member, and the third shelf member are constructed as a single piece.

6. The shelf unit of claim 1 further comprising an adhesive on the rear surface of the mounting plate.

7. A shelf unit, comprising:
a mounting plate having a front surface, a rear surface, a top end, a bottom end, a first side, and a second side, wherein the mounting plate is adapted to be secured to a vertical structure;
a first shelf member extending perpendicularly from the mounting plate, the first shelf member having a first end and a second end;
a second shelf member extending perpendicularly from the mounting plate such that the second shelf member is vertically and horizontally offset from the first shelf member;
a third shelf member extending perpendicularly from the mounting plate such that the third shelf member is vertically and horizontally offset from the first shelf member; and
an adhesive applied to at least a portion of the rear surface of the mounting plate.

8. The shelf unit of claim 7 wherein the second shelf member extends beyond the first end of the first shelf member, and wherein the third shelf member extends beyond the second end of the first shelf member.

9. The shelf unit of claim 8 herein the second shelf member and the third shelf member are in a co-planar relationship with respect to one another.

10. The shelf unit of claim 9 herein the mounting plate, the first shelf member, the second shelf member, and the third shelf member are constructed as a single piece.

11. A shelf kit, comprising:
a shelf unit comprising:
a mounting plate having a front surface, a rear surface, a top end, a bottom end, a first side, and a second side;
a first shelf member extending perpendicularly from the mounting plate, the first shelf member having a first end and a second end;
a second shelf member extending perpendicularly from the mounting plate such that the second shelf member is vertically and horizontally offset from the first shelf member;
a third shelf member extending perpendicularly from the mounting plate such that the third shelf member is vertically and horizontally offset from the first shelf member; and
an adhesive applied to at least a portion of the rear surface of the mounting plate; and
a sealant applicable along the perimeter of the mounting plate between the mounting plate and the vertical surface.

12. The shelf kit of claim 11 wherein the second shelf member extends beyond the first end of the first shelf member, and wherein the third shelf member extends beyond the second end of the first shelf member.

13. The shelf kit of claim 12 herein the second shelf member and the third shelf member are in a co-planar relationship with respect to one another.

14. The shelf kit of claim 13 herein the mounting plate, the first shelf member, the second shelf member, and the third shelf member are constructed as a single piece.

15. A method of forming a shelf, comprising:
obtaining a shelf unit comprising:
a mounting plate having a front surface, a rear surface, a top end, a bottom end, a first side, and a second side;
a first shelf member extending perpendicularly from the mounting plate;
a second shelf member extending perpendicularly from the mounting plate such that the second shelf is vertically and horizontally offset from the first shelf member; and
a third shelf member extending perpendicularly from the mounting plate such that the third shelf member is vertically and horizontally offset from the first shelf member; and
adhering the rear surface of the mounting plate to a vertical surface.

16. The method of claim 15 further comprising:
applying a sealant along the perimeter of the mounting plate between the mounting plate and the vertical surface.
